(19) United States
(12) Patent Application Publication
(10) Pub. No.: US 2026/0216680 A1
(43) Pub. Date: Jul. 30, 2026

(54) MICROFLUIDIC-BASED ON-CHIP ELECTROCATALYTIC MICROCELL SYSTEM AND METHOD FOR FABRICATING THE SAME

(71) Applicant: City University of Hong Kong, Hong Kong (HK)

(72) Inventors: Hua ZHANG, Hong Kong (HK); Wenze CHEN, Hong Kong (HK); Ziyun LI, Hong Kong (HK)

(21) Appl. No.: 19/038,718

(22) Filed: Jan. 28, 2025

(51) Int. Cl. B01J 10/00; B01L 3/00

(52) U.S. Cl. CPC B01J 10/007; B01L 3/502707; B01L 3/502715; B01J 2219/00065; B01J 2219/00164; B01J 2219/0025; B01J 2219/00355; B01L 2200/0684; B01L 2200/146; B01L 2300/0645; B01L 2400/0481

(57) ABSTRACT

The present invention relates to a microfluidic-based on-chip electrocatalytic microcell (OCEMC) system optimized for CO₂ reduction reactions (CO₂RR). Utilizing micro-nano fabrication and microfluidic control, the system enables precise diffusion control and minimizes external interferences. The design incorporates integrated microelectrodes and multi-functional components, including a gas-liquid mixing system, a flow stabilization system, and in situ analytical tools such as Raman spectroscopy and differential electrochemical mass spectrometry (DEMS). The OCEMC system enhances mass transfer efficiency, improves Faradaic efficiency, and supports phase-dependent studies, enabling comprehensive evaluations of catalytic mechanisms. This scalable and versatile platform expands the potential of electrocatalysis research and industrial applications by facilitating the rational design of high-performance catalysts.

### FIELD OF THE INVENTION

The present invention generally relates to at least the fields of nanotechnology, electrochemistry, materials science, catalysisand microfluidics. More specifically, the present invention provides a new electrocatalytic system, that is unaffected to external factors and solely governed by diffusion control.

### BACKGROUND OF THE INVENTION

Carbon dioxide reduction reaction (CO₂RR) is a critical approach to address global warming by converting CO₂ into valuable products, while also offering a significant technological pathway for renewable energy conversion and storage. The electrocatalytic CO₂RR represents a promising approach for transforming renewable electricity into valuable fuels and chemical feedstocks, playing a crucial role in energy conversion technologies. The reaction process in CO₂RR is strongly influenced by catalyst performance and diffusion dynamics, which govern the reactant/intermediate transport and modulate reaction rates. Precise design and management of catalyst and diffusion processes are therefore essential for maximizing reaction efficiency and achieving optimal performance in CO₂RR systems.

In evaluating catalyst performance, various external factors often introduce interference. Currently, two primary types of electrocatalytic cells are employed for CO₂RR, each with inherent limitations. Aqueous-fed cells encounter significant challenges in mass transfer due to low CO₂ solubility and competing hydrogen evolution reaction (HER) activity. In contrast, gas diffusion electrode (GDE)-based flow cells exhibit improved diffusion efficiency but face complex interfacial issues that limit overall performance. Both types of cells struggle to fully exploit intrinsic catalytic activity and adequately address mass transfer limitations. This highlights the urgent need for a novel electrocatalytic system.

YANG, Huan, et al. review recent applications of the OCEM platform, highlighting advancements in in situ electron/electrochemical measurements and the tunable microstructure of individual catalysts (Yang, H., He, Q., Liu, Y., Li, H., Zhang, H., & Zhai, T. (2020). On-chip electrocatalytic microdevice: an emerging platform for expanding the insight into electrochemical processes. Chemical Society Reviews, 49 (10), 2916-2936). However, previous studies have primarily focused on catalytic behavior in static electrolytes, which presents significant limitations.

YU, Yifu, et al. utilize OCEM to reveal the superior HER activity of TMDs possessing the unconventional 1T′-phase (YU, Yifu, et al. High phase-purity 1T′-MoS₂-and 1T′-MoSe₂-layered crystals. Nature chemistry, 2018, 10.6:638-643). However, this superior HER activity has obscured the intrinsic CO₂RR potential of 1T′-TMDs.

Q I, Junlei, et al. combine OCEM with a microfluidic setup to investigate the influence of mass transfer on ORR (Q I, Junlei, et al. On-chip investigation of electrocatalytic oxygen reduction reaction of 2D materials. Small, 2022, 18.47:2204010). However, the device's unidirectional liquid flow restricts it to real-time electrochemical signal detection, without the capability to collect reaction products.

Therefore, there is a need to develop a new electrochemical system and create a clean, straightforward reaction platform free from external interferences. This platform should effectively address CO₂ mass transfer challenges while accurately capturing the intrinsic activity of catalysts.

### SUMMARY OF THE INVENTION

To overcome the challenges mentioned above and address the limitations of current electrocatalytic cell designs, the present invention introduces a microfluidic-based on-chip electrocatalytic microcell system. This system is capable of investigating diffusion-driven processes while minimizing external interferences and enhancing reaction efficiency in CO₂RR processes.

In a first aspect, the present invention provides a microfluidic-based on-chip electrocatalytic microcell system, which includes: (1) a microfluidic chamber configured to introduce an electrolyte and a gaseous reactant through independent channels, wherein the microfluidic chamber comprises inlet ports and outlet ports for continuous flow of the electrolyte, and integrated electrodes positioned to enable electrocatalytic reactions, (2) a gas-liquid mixing system with a mixing chamber configured to ensure homogeneous mixing of the gaseous reactant and the electrolyte, wherein the gas-liquid mixing system connect with the microfluidic chamber, (3) a flow power system with at least one peristaltic pump connected to the microfluidic chamber to control the flow rate of the electrolyte within the microfluidic chamber, and (4) a flow stabilization system with a flow-dampening chamber to mitigate flow fluctuations and maintain stable liquid delivery to the microfluidic chamber. The microfluidic-based on-chip electrocatalytic microcell system is capable of optimizing diffusion-driven reactions, minimizing external interference, and facilitating reaction efficiency in carbon dioxide reduction reactions (CO₂RR).

In one embodiment, the electrolyte includes a thin-layer flow phase electrolyte.

In one embodiment, the microfluidic chamber is fabricated using polydimethylsiloxane (PDMS) treated with oxygen plasma to create a hydrophilic surface.

In one embodiment, the gas-liquid mixing system includes an injection port for collecting gas products post-reaction.

In one embodiment, the integrated electrodes include materials selected from gold, copper, platinum, and transition metal dichalcogenides (TMDs), and the integrated electrodes are recessed and coated with a polymer to create a defined reaction area.

In one embodiment, the flow power system includes a feedback mechanism to dynamically adjust the flow rate based on detected pressure changes.

In one embodiment, the flow stabilization system includes a gas collection chamber designed to remove air bubbles from the liquid electrolyte before entry into the microfluidic chamber.

In another embodiment, the microfluidic-based on-chip electrocatalytic microcell system further including in situ analytical tools for real-time monitoring of catalytic reactions.

In one embodiment, the in situ analytical tools include Raman spectroscopy and differential electrochemical mass spectrometry (DEMS).

The on-chip electrocatalytic microcell (OCEM) utilizes micro-nano fabrication techniques to create precise microelectrodes that are shielded from external interference and employs microfluidic control to optimize mass transfer rates. It offers a controlled environment ideal for investigating specific factors such as site specificity, external fields, and phase engineering.

Similar to the investigation of heterogeneous catalysis at the solid-gas interface under ultra-high vacuum conditions, the OCEM platform offers a comparable setup for studying catalytic reactions at the solid-liquid interface in electrocatalysis.

In a second aspect, the present invention provides a method for fabricating a microfluidic-based on-chip electrocatalytic microcell system, including fabricating a microelectrode array on a substrate to create precise patterns; assembling a microfluidic chamber; and integrating a gas-liquid mixing system, a flow power system, and a flow stabilization system with the microfluidic chamber to form an assembled microfluidic-based on-chip electrocatalytic microcell system.

In one embodiment, the microelectrode array is fabricated using gold, copper, platinum, or 2D transition metal dichalcogenides (TMDs) to enhance catalytic performance.

In one embodiment, the substrate includes silicon wafer.

In one embodiment, the step of assembling a microfluidic chamber includes preparing a polydimethylsiloxane (PDMS) chamber with pre-defined inlet and outlet ports; and attaching the PDMS chamber to the microelectrode array using plasma activation.

In one embodiment, the PDMS is fabricated by mixing a PDMS monomer and a crosslinker in a 9-15:1 ratio, degassing under vacuum, and curing at 90-110° C. for 20-40 minutes.

Preferably, the PDMS is fabricated by mixing a PDMS monomer and a crosslinker in a 10:1 ratio, degassing under vacuum, and curing at 90-110° C. for 20-40 minutes.

In one embodiment, the plasma activation of the PDMS chamber is performed using oxygen plasma at a pressure of 0.1-0.5 Torr, a power of 10-20 W, and a duration of 1-10 minutes to enhance adhesion to the silicon wafer.

In one embodiment, the gas-liquid mixing system includes a mixing chamber designed to ensure thorough gas-liquid interaction and prevent bubble formation before introduction into the microfluidic chamber.

In one embodiment, the flow power system utilizes a peristaltic pump to maintain a flow rate between 5 and 100 mL/min, ensuring consistent electrolyte delivery and optimal mass transfer.

In one embodiment, the flow stabilization system comprises a flow-dampening chamber configured to stabilize liquid flow and eliminate pulsations caused by the peristaltic pump.

In another embodiment, the method further including integrating in situ analytical tools comprising Raman spectroscopy and differential electrochemical mass spectrometry (DEMS), for real-time monitoring of catalytic reactions.

In yet another embodiment, the method further including validating the assembled microfluidic-based on-chip electrocatalytic microcell system for electrical continuity and sealing performance, ensuring minimal dead volume and optimized mass transfer for CO₂RR applications.

This invention combines microfluidics with OCEM technology to optimize CO₂ mass transfer efficiency for CO₂RR. The CO₂RTR experiments have been conducted using gold, copper, and platinum microelectrodes as standardized catalysts. This integrated approach harnesses the advantages of both technologies, aiming to deliver superior performance in CO₂RR applications.

The present invention successfully overcomes the limitations of conventional OCEM systems, which are typically confined to HER and oxygen evolution reactions (OER) due to poor mass transport in static electrolytes. This advancement significantly broadens the application potential of OCEM, enabling its use in a wider range of electrochemical processes.

### Advantages of the Invention

(1) The system is designed to significantly improve CO₂ mass transfer rates, thereby optimizing reaction performance. This feature is particularly beneficial for the development of high-performance CO₂RR catalysts, advancing the efficiency of electrochemical CO₂ conversion processes.
(2) The system enables the construction of a model catalysis at the solid-liquid interface, allowing for the exploration of reaction kinetics through the manipulation of individual factors. This approach deepens the understanding of CO₂RR catalytic mechanisms and provides valuable insights for guiding the top-level design of more efficient catalysts.
(3) The system is highly scalable and integrates in situ analytical techniques, making it adaptable to a wide range of diffusion-controlled catalytic reactions. This versatility extends the potential applications of the system beyond CO₂RR, enabling its use in various electrochemical processes.

### BRIEF DESCRIPTION OF THE DRAWINGS

Embodiments of the invention are described in more details hereinafter with reference to the drawings, in which:

FIG. 1A shows a schematic illustration of the setup for CO₂RR. FIG. 1B shows a photograph of microfluidic-based OCEMC of the present invention;

FIG. 2 shows a schematic of the prepatterned chip. The chip features 32 gold contact pads for electrical conduction. The light gray area represents the effective region, with gold position markers used for electron-beam lithography during device fabrication;

FIG. 3 shows a schematic of the 2D 2H—WS₂ microelectrode fabrication process, including chip preparation, material preparation, electrode deposition, spin coating of poly (methyl methacrylate) (PMMA), selective exposure, and OCEMC system assembly;

FIG. 4A shows a PDMS chamber with a concave microchannel in the middle and four holes. The upper and lower holes are inserted with 2 mm Ag/AgCl electrodes and 0.6 mm platinum wire electrodes, while the left and right holes are inserted with 0.8 mm sample needles.

FIG. 4B shows a schematic diagram of the PDMS chamber, with measurements in millimeters.

FIGS. 4C-4D show the overall photography of OCEMC, with an acrylic board at the top, followed by a PDMS chamber, a chip, and another acrylic board. The entire structure is secured by four screws at the corners, with the seal ensured by the adhesion between PDMS and silicon.

FIGS. 4E-4F shows the models of OCEMC. The electrolyte inside the PDMS chamber is a thin layer flow phase design to enhance mass transfer rates;

FIG. 5A shows a photograph of gas-liquid mixing system (GLMS) of the present invention. FIG. 5B shows a schematic diagram of the system's principle;

FIG. 6A shows a photograph of flow power system (FPS) of the present invention.

FIGS. 6B-6C show photographs and principle of flow stabilization system (FSS) of the present invention; and

FIGS. 7A-7B show photography and schematic diagram of in-situ DEMS.

FIGS. 7C-7D show photography and schematic diagram of in-situ Raman device.

### DETAILED DESCRIPTION

The development of high-precision, durable microelectrodes is pivotal for advancing microfluidic-based electrochemical systems, particularly in applications such as CO₂RR and other electrochemical analyses. Existing techniques often face challenges in electrode fabrication, material compatibility, and microcell integration. This invention addresses these challenges by presenting a novel approach to fabricate microelectrodes using materials including gold, copper, platinum, and two-dimensional transition metal dichalcogenides (TMDs). These microelectrodes are seamlessly integrated into a microfluidic on-chip electrochemical microcell (OCEMC), offering enhanced functionality and versatility.

In particular, the present invention relates to a microfluidic-based OCEMC design, which features the fabrication of microelectrodes on a substrate (e.g., silicon wafer). This configuration allows precise control over the diffusion of catalytic species by tuning flow rates and electrode dimensions, thereby optimizing CO₂RR efficiency. The integration of microfluidics with on-chip electrochemical systems eliminates constraints associated with static electrolytes, facilitating dynamic and controlled reaction environments.

In one embodiment, the microelectrodes used in the system include gold, platinum, and copper, all of which are known for their electrochemical stability and catalytic activity.

By integrating microfluidics with OCEM, this approach overcomes the limitations imposed by static electrolytes. All components and materials necessary for constructing the platform, including solvents and chemicals, are sourced exclusively from publicly accessible channels.

By creating a controlled microenvironment free from external disturbances, this system operates exclusively under diffusion control. This approach provides an accurate representation of the intrinsic catalytic activity of the materials under investigation, enabling rational catalyst design and optimization.

The newly developed microfluidic-based OCEMC system enables a detailed investigation of individual diffusion variables that influence electrocatalytic reactions. This shift from conventional methods enables the development of an advanced model, ideal for conducting in-depth mechanistic studies and obtaining precise performance measurements.

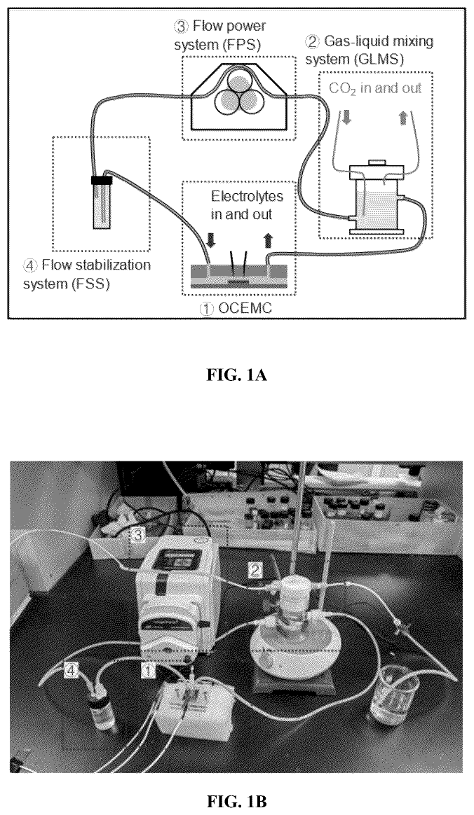

FIGS. 1A-1B illustrates the design and implementation of the microfluidic-based OCEMC system for conducting CO₂RR. The system is comprised of four interconnected functional components: the OCEMC, a GLMS system, a FPS system, and a FSS system. All interconnected via microfluidic channels.

FIG. 1A shows a typical schematic illustration of the OCEMC setup, highlighting the following interconnected components:

### (1) OCEMC:

The OCEMC serves as the central component for electrochemical reactions, and its assembly is secured with four screws positioned at the corners. OCEMC contains a microfluidic chamber (e.g., PDMS chamber) designed for the introduction of electrolyte and CO₂, inlet and outlet ports for the continuous flow of electrolyte solutions, integrated electrodes (working, counter, and reference electrodes) enabling precise electrochemical reactions under controlled conditions. The PDMS chamber is securely bonded to the silicon wafer, ensuring a tight and airtight seal, while the microchannels are specifically designed to optimize the flow of the electrolyte. To complete the OCEMC assembly, syringe needles are inserted into the left and right openings, while a platinum wire counter electrode and an Ag/AgCl reference electrode are positioned in the lower and upper openings, respectively. The electrolyte and CO₂ gas are introduced into the microcell through independent channels, allowing effective contact and enhanced mass transfer. The system ensures minimal dead volume, facilitating high reaction efficiency.

### (2) GLMS:

It ensures homogeneous mixing of CO₂ gas and the liquid electrolyte before their entry into the OCEMC. The GLMS includes a gas input port for CO₂ delivery, a specially designed mixing chamber to create a uniform gas-liquid interface. This configuration enhances the interaction between dissolved CO₂ and the active catalytic sites in the microcell.

### (3) FPS:

It is responsible for maintaining a consistent flow rate of fluids through the system. It employs a peristaltic pump to drive the electrolyte and gas-liquid mixtures through the microfluidic channels. The pump enables precise control of flow rates to optimize reaction conditions.

### (4) FSS:

It mitigates fluctuations in flow rate, ensuring stable fluid delivery to the OCEMC. It comprises a series of flow-dampening chambers and feedback loops to prevent pulsation effects from the peristaltic pump.

By precisely controlling flow rates and diffusion dynamics, the system significantly enhances reaction performance. For example, gold electrodes demonstrated a 50-70% increase in current density and a 20% improvement in CO Faradaic efficiency (FE) under optimal conditions.

Moreover, the advanced analytical tools, in situ Raman spectroscopy and online differential electrochemical mass spectrometry (DEMS), have been utilized to investigate the surface kinetic processes of gold electrodes, offering valuable insights into diffusion kinetics.

In the present invention, CO₂RR activities of 2H and 1T′ phases of WS₂ have been evaluated to explore phase-dependent effects. Notably, under controlled diffusion conditions, 1T′-WS₂ demonstrates superior CO₂RR activity compared to 2H—WS₂, marking a significant observation of 1T′-WS₂ exhibiting CO₂RR activity in an aqueous electrolyte system.

In another aspect the present invention provides a method for fabricating a microfluidic-based on-chip electrocatalytic microcell system, including fabricating a microelectrode array on a substrate to create precise patterns; assembling a microfluidic chamber; and integrating a gas-liquid mixing system, a flow power system, and a flow stabilization system with the microfluidic chamber to form an assembled microfluidic-based on-chip electrocatalytic microcell system.

In one embodiment, the microelectrode array may be fabricated using gold, copper, platinum, or 2D transition metal dichalcogenides (TMDs) to enhance catalytic performance.

In one embodiment, the substrate may be silicon wafer.

In one embodiment, the step of fabricating can be photolithography process or electron beam lithography process. The photolithography process includes spin-coating the wafer with photoresist, exposing it to ultraviolet light through a patterned mask, and developing the exposed pattern in a developer solution. The electron beam lithography process is conducted with a beam current of 0.15 nA, an electron dose of 210 μC/cm², and a spacing of 0.7 to achieve precise electrode patterns.

In one embodiment, the step of assembling a microfluidic chamber includes preparing a polydimethylsiloxane (PDMS) chamber with pre-defined inlet and outlet ports; and attaching the PDMS chamber to the microelectrode array using plasma activation.

In one embodiment, the PDMS is fabricated by mixing a PDMS monomer and a crosslinker the PDMS is fabricated by mixing a PDMS monomer and a crosslinker in a 9-15:1 ratio, degassing under vacuum, and curing at 90-110° C. for 20-40 minutes

Preferably, the PDMS is fabricated by mixing a PDMS monomer and a crosslinker in a 10:1 ratio, degassing under vacuum, and curing at 100° C. for 30 minutes.

The plasma activation of the PDMS chamber is performed using oxygen plasma at a pressure of 0.4 Torr, a power of 18 W, and a duration of 5 minutes to enhance adhesion to the silicon wafer.

The gas-liquid mixing system includes a mixing chamber designed to ensure thorough gas-liquid interaction and prevent bubble formation before introduction into the microfluidic chamber. The flow stabilization system includes a flow-dampening chamber configured to stabilize liquid flow and eliminate pulsations caused by the peristaltic pump.

The flow power system utilizes a peristaltic pump to maintain a flow rate between 5 and 100 mL/min, ensuring consistent electrolyte delivery and optimal mass transfer.

In another embodiment, the method further including validating the assembled microfluidic-based on-chip electrocatalytic microcell system for electrical continuity and sealing performance, ensuring minimal dead volume and optimized mass transfer for CO₂RR applications.

Beyond its fundamental research applications, the system proves highly versatile, extending its utility to areas such as diffusion-controlled electrocatalysis (e.g., oxygen reduction reaction) and biosensing technologies (e.g., dopamine detection). This versatility highlights its potential to advance both fundamental understanding and practical applications in electrochemistry and related fields.

### EXAMPLE

### Example 1

Preparation of a Silicon Chip with Gold Contact Pads

16 mm×16 mm SiO₂ (285 nm)/Si chips with a prepatterned set of 32 Au contact pads are fabricated via conventional photolithography and thermal evaporation of Cr/Au. First, the SiO₂/Si wafer (4 inch; SVM) is sequentially rinsed with acetone, isopropanol and DI water, and then dried with nitrogen (N₂). After that, the clean wafer is put onto a spin-coater (Laurell). A photoresist (AZ5214; AZ Electronic Materials) is dispersed on the center of the wafer and then the wafer is spun at a spreading speed of 1000 rpm for 10 s, followed by a spinning speed of 4000 rpm for 60 s in a darkroom. The wafer is then baked on a hot plate at 100° C. for 90 s. Next, the wafer is positioned on a mask aligner, and a patterned mask (customized, as shown in FIG. 2) is placed on top. The wafer is then exposed to a dose power of 15 mW·cm⁻² for 18 s. Subsequently, the exposed wafer is immersed in a developer (AZ 400K/deionized (DI) water=1:4; AZ Electronic Materials, AZ 400K) for 70 s, then rinsed with DI water for 10 s to fix the pattern. Later, it was dried with nitrogen gas for the developed wafer. Finally, the developed wafer is dried with nitrogen gas. After depositing Cr and Au (5 nm and 40 nm, respectively) using standard physical vapor deposition (PVD) procedures (NANO 36, Kurt. J. Lesker), the wafer is immersed in acetone for 1 h to remove the photoresist. It is then rinsed with acetone, IPA, and DI water, followed by drying with N₂ flow. Finally, the wafer is cut into several small chips along the pattern edges, each with a size of 16 mm×16 mm.

### Example 2

### Fabrication of Gold Microelectrode

0.3 mL of 495 PMMA A8 (purchased from KAYAKU) is dropped onto the chip made from Example 1. The chip is then spun at a spreading speed of 1000 rpm for 10 s, followed by a spinning speed of 3000 rpm for 50 s. After spinning, the wafer is baked at 150° C. for 3 mins. Electron beam lithography (EBL; TECAN VEGA) is used to expose the areas designated for the gold microelectrodes. The EBL parameters are as follows: a beam current of 0.15 nA, an electron dose of 210 μC·cm⁻² and a spacing of 0.7.

The exposed shapes are squares, with areas ranging from 100 to 10,000 μm². Furthermore, channels approximately 5 μm in width are defined to establish connections between the gold pads and the microelectrodes. After EBL, the chip is immersed in a SU-8 developer (KAYAKU) for 30 s, then rinsed immediately with IPA, followed by drying with N₂ flow. The exposure and resist development are then examined using an optical microscope to ensure their success.

Next, Cr and Au (5 nm and 40 nm, respectively) are deposited using PVD procedures. The chip is then immersed in acetone for 1 hour to remove the PMMA, rinsed with acetone, IPA, and DI water, and finally dried with N₂ flow. Subsequently, the chip with gold microelectrode is spin-coated with PMMA at 1000 rpm for 10 s, and 3000 rpm for 50 s, and then baked at 150° C. for 3 min. Such procedures are repeated once more to achieve a PMMA thickness of 2 μm, ensuring the elimination of any remaining solvent and pinholes. Finally, the gold microelectrodes are exposed using EBL, resulting in recessed microelectrodes with PMMA channels. EBL parameters are as follows: a beam current of 0.15 nA, an electron dose of 210 μC·cm⁻² and a spacing of 0.7.

### Example 3

### Fabrication of Copper Microelectrode

0.3 mL of PMMA is dropped onto the chip made from Example 1. The chip is then spun at a spreading speed of 1000 rpm for 10 s, followed by a spinning speed of 3000 rpm for 50 s. After spinning, the wafer is baked at 150° C. for 3 mins. EBL is used to expose the areas designated for the copper microelectrodes. The EBL parameters are as follows: a beam current of 0.15 nA, an electron dose of 210 μC·cm⁻² and a spacing of 0.7.

The exposed shapes are squares, with areas ranging from 100 to 10,000 μm². Furthermore, channels approximately 5 μm in width are defined to establish connections between the gold pads and the microelectrodes. After EBL, the chip is immersed in the SU-8 developer for 30 s, then rinsed immediately with IPA, followed by drying with N₂ flow. The exposure and resist development are then examined using an optical microscope to ensure their success.

Next, Cr and Cu (5 nm and 40 nm, respectively) are deposited using PVD procedures. The chip is then immersed in acetone for 1 hour to remove the PMMA, rinsed with acetone, IPA, and DI water, and finally dried with N₂ flow. Subsequently, the chip with copper microelectrode is spin-coated with PMMA at 1000 rpm for 10 s, and 3000 rpm for 50 s, and then baked at 150° C. for 3 min. Such procedures are repeated once more to achieve a PMMA thickness of 2 μm, ensuring the elimination of any remaining solvent and pinholes. Finally, the copper microelectrodes are exposed using EBL, resulting in recessed microelectrodes with PMMA channels. EBL parameters are as follows: a beam current of 0.15 nA, an electron dose of 210 μC·cm⁻² and a spacing of 0.7.

### Example 4

### Fabrication of Platinum Microelectrode

0.3 mL of PMMA is dropped onto the chip made from Example 1. The chip is then spun at a spreading speed of 1000 rpm for 10 s, followed by a spinning speed of 3000 rpm for 50 s. After spinning, the wafer is baked at 150° C. for 3 mins. EBL is used to expose the areas designated for the platinum microelectrodes. The EBL parameters are as follows: a beam current of 0.15 nA, an electron dose of 210 μC·cm⁻² and a spacing of 0.7.

The exposed shapes are squares, with areas ranging from 100 to 10,000 μm². Furthermore, channels approximately 5 μm in width are defined to establish connections between the gold pads and the microelectrodes. After EBL, the chip is immersed in the SU-8 developer for 30 s, then rinsed immediately with IPA, followed by drying with N₂ flow. The exposure and resist development are then examined using an optical microscope to ensure their success.

Subsequently, the chip, after resist development, and the slice are subjected to plasma treatment in a plasma cleaner to improve the adhesion of platinum. The treatment uses air as the gas, with a pressure of 0.5 Torr, a power of 18 W, and a treatment time of 5 minutes. Following this, the chip and slice are fixed onto a deposition substrate, and platinum is evaporated and deposited onto them using an electron beam evaporation system, with a target platinum thickness of 50 nm.

Electron beam evaporation, similar to thermal evaporation but with differences in power supply, involves placing platinum pellets in a crucible filled two-thirds full. The platinum is then heated and evaporated using a focused electron beam, allowing it to deposit onto the chip and slice. Parameters such as pressure, substrate rotation, and power control are maintained identical to thermal evaporation, with a deposition rate of 1 Å/s recommended for platinum.

After electron beam evaporation, the chip is immersed in acetone for 1 hour to remove the PMMA, then rinsed with acetone, IPA, and DI water, and finally dried with N₂ flow. The chip with the platinum microelectrode is then spin-coated with PMMA at 1000 rpm for 10 seconds, followed by 3000 rpm for 50 seconds, and baked at 150° C. for 3 minutes. Such procedures are repeated once more to achieve a PMMA thickness of 2 μm, ensuring the elimination of any remaining solvent and pinholes. Finally, the platinum microelectrodes are exposed using EBL, resulting in recessed microelectrodes with PMMA channels. EBL parameters are as follows: a beam current of 0.15 nA, an electron dose of 210 μC·cm⁻² and a spacing of 0.7.

### Example 4

### Fabrication of 2D Transition Metal Dichalcogenide (TMD) Microelectrodes

The preparation of 2D TMD microdevices is more complex than the preparation of metal microelectrodes and involves a certain yield rate.

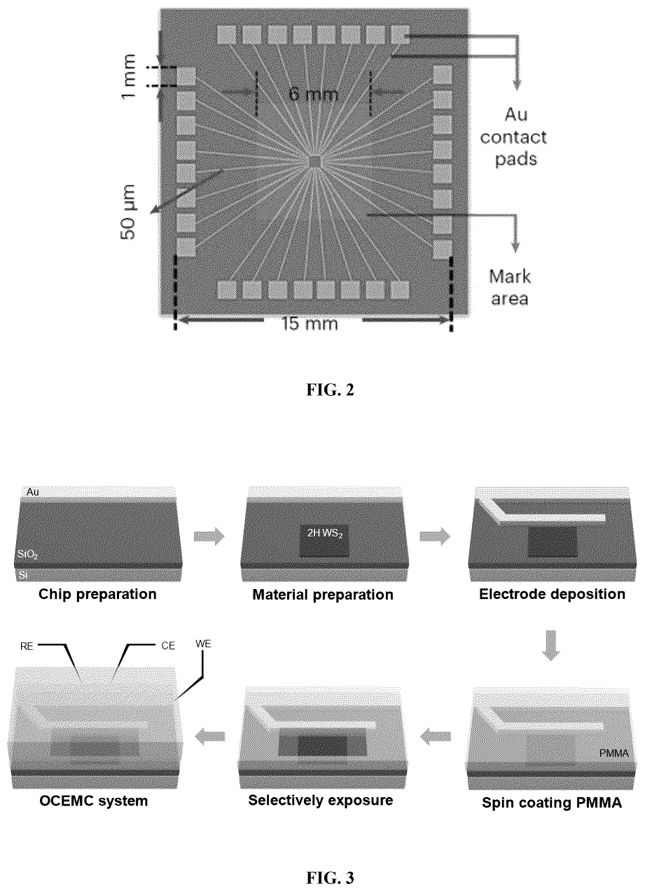

Generally, the preparation of 2D 2H—WS₂ strictly follows the following steps (FIG. 3): First, the chip with a prepatterned gold pad is rinsed with acetone, IPA, and DI water, followed by drying with N₂ flow. Subsequently, the chip is placed into a plasma cleaner (Harric Plasma, cat. no. PDC-32G-2) for plasma treatment to enhance the adhesion of 2H—WS₂. The plasma parameter: gas: argon (>99.999%; Linde HKO); pressure: 0.4 Torr; power: 18 W; time: 5 min.

The mechanical exfoliation of 2H—WS₂ crystal (>99.99%; KJMTI) is placed onto the chip. The optical microscope is used to screen materials that are large, uniform, and have a thickness of approximately 10-30 nm. Maintaining a specific thickness ensures that the electrode has sufficient mechanical strength to withstand shear forces from flowing electrolytes and interference from bubbles.

0.3 mL of PMMA is dropped onto the chip with 2H—WS₂ and spun at a spreading speed of 1000 rpm for 10 s and a spinning speed of 3000 rpm for 50 s, and then baked at 150° C. for 3 min. EBL is used to expose the areas for contacting gold. Channels approximately 5 μm in width are defined to establish connections between the gold pads and 2H—WS₂. The EBL parameters are as follows: a beam current of 0.15 nA, an electron dose of 210 μC·cm⁻² and a spacing of 0.7.

After EBL, the chip is immersed in the SU-8 developer for 30 s, then rinsed immediately with IPA, followed by drying with N₂ flow. The exposure and resist development are then examined using an optical microscope to ensure their success. Next, Cr and Au (5 nm and 40 nm, respectively) are deposited using PVD procedures. The chip is then immersed in acetone for 1 hour to remove the PMMA, rinsed with acetone, IPA, and DI water, and finally dried with N₂ flow. The chip is spin-coated with PMMA at 1000 rpm for 10 s and 3000 rpm for 50 s, and then baked at 150° C. for 3 min. Such procedures are repeated once more to achieve a PMMA thickness of 2 μm, ensuring the elimination of any remaining solvent and pinholes.

Finally, the 2H—WS₂ microelectrodes are exposed using EBL, resulting in recessed microelectrodes with PMMA channels. EBL parameters are as follows: a beam current of 0.15 nA, an electron dose of 210 μC·cm⁻² and a spacing of 0.7. Typically, the exposure window is rectangular, with the edges kept at 3 μm or more from the constructed gold electrodes to prevent electrolyte contact with the gold electrodes and potential electrical leakage.

For the fabrication of 2D 2H—MoS₂ microelectrodes, the process is consistent with that of the 2D 2H—WS₂ microelectrodes, except that 2H—WS₂ is replaced with 2H—MoS₂ (>99.99%; KJMTI).

Furthermore, the preparation of 1T′-WS₂ microdevices is like 2H—WS₂. However, it is prone to phase transition and is more difficult to peel off compared to 2H phase, leading to a further reduction in its yield rate.

Generally, the preparation of 2D 1T′-WS₂ strictly follows the following steps: First, the chip with a prepatterned gold pad is rinsed with acetone, IPA, and DI water, and then dried with N₂ flow. Subsequently, the chip is placed into a plasma cleaner for plasma treatment to enhance the adhesion of 1T′-WS₂. The plasma parameter: gas: argon; pressure: 0.4 Torr; power: 18 W; time: 5 min.

1T′-WS₂ is synthesized from controlled phase transformation of conventional 2H—WS₂. Typically, 1.0 mmol of 2H—WS₂ powder (99.8%; Alfa Aesar) is mixed with K₂C₂O₄·H₂O (98%; Aladdin) and S powder (99.98%; Sigma Aldrich) in a molar ratio of 1:1.1:10. The mixture is then ground in an agate mortar for 10 minutes. The resulting homogeneous mixture is transferred to an alumina crucible placed in the center of a quartz tube with a diameter of 2.5 cm.

The quartz tube is subjected to three cycles of vacuum and Ar purging to remove the air inside. The tube is then flushed with an H₂ (>99.999%; Linde HKO)/Ar gas mixture (mix at 30%/70%) at a total flow rate of 100 standard cubic centimeters per minute (sccm) for 15 min. The tube is placed in a tube furnace preheated to 800° C. and maintained at that temperature for 4 hrs. The tube furnace is then turned off and allowed to cool to room temperature naturally. The product is washed with Milli-Q water until the pH of the suspension reached around 7.0. Subsequently, the suspension is soaked in Milli-Q water for 24 h and then transferred to an acetonitrile (HPLC; Sigma-Aldrich) solution containing iodine (98%; TCL) (concentrate=1.5 g/50 mL) for another 24 hrs. Finally, the product is dried in a vacuum oven at room temperature to yield 1T′-WS₂ crystals. The yield of 1T′-WS₂ product after the reaction can be as high as approximately 50%.

The mechanically exfoliated 1T′-WS₂ crystal is placed onto the chip. An optical microscope is used to screen materials that are large, uniform, and have a thickness of approximately 10-30 nm. Ensuring a specific thickness provides the electrode with adequate mechanical strength to resist shear forces from flowing electrolytes and disruptions caused by bubbles.

For electrode deposition, 0.3 mL of PMMA is dropped onto the chip containing 1T′-WS₂ and spun at a spreading speed of 1000 rpm for 10 s, followed by a spinning speed of 3000 rpm for 50 s, and then baked at 90° C. for 60 mins. 1T′-WS₂ is prone to phase transition and begins to slowly transform into the 2H phase at temperatures near 117° C. Therefore, the baking process should be conducted at a lower temperature over an extended period to prevent phase transition.

EBL is used to expose the areas for contacting gold. Channels approximately 5 μm in width are defined to establish connections between the gold pads and 1T′-WS₂. The EBL parameters are as follows: a beam current of 0.15 nA, an electron dose of 210 μC·cm⁻² and a spacing of 0.7. After EBL, the chip is immersed in the SU-8 developer for 30 s, then rinsed immediately with IPA, followed by drying with N₂ flow. The exposure and resist development are then examined using an optical microscope to ensure their success.

Next, Cr and Au (5 nm and 40 nm, respectively) are deposited using PVD procedures. The chip is then immersed in acetone for 1 hour to remove the PMMA, rinsed with acetone, IPA, and DI water, and finally dried with N₂ flow. The chip is spin-coated with PMMA at 1000 rpm for 10 s and 3000 rpm for 50 s, and then baked at 90° C. for 5 min. The chip is spin-coated again with same parameter and baked at 90° C. for another 60 min to achieve a PMMA thickness of 2 μm, ensuring the elimination of any remaining solvent and pinholes.

Finally, the 1T′-WS₂ microelectrodes are exposed using EBL, resulting in recessed microelectrodes with PMMA channels. EBL parameters are as follows: a beam current of 0.15 nA, an electron dose of 210 μC·cm⁻² and a spacing of 0.7. Typically, the exposure window is rectangular, with the edges kept at 3 μm or more from the constructed gold electrodes to prevent electrolyte contact with the gold electrodes and potential electrical leakage.

The preparation of 1T′-WS₂ microdevices is like 2H—WS₂. However, it is prone to phase transition and is more difficult to peel off compared to 2H phase, leading to a further reduction in its yield rate.

### Example 5

### Design of Microfluidic-Based OCEMC

In a complete microfluidic-based OCEMC system, it is essential not only to control the mass transfer rate but also to analyse the products generated from CO₂RR, including those in both the liquid and gas phases. Due to the extremely small size of the electrodes, the gas and liquid products generated often fall below the detection limits of analytical instruments such as gas chromatography (GC). Therefore, the system incorporates the capability to collect both gas-phase and liquid-phase products.

FIGS. 1A-1B illustrates the design and implementation of the microfluidic-based OCEMC system for conducting CO₂RR. FIG. 1A shows a typical schematic illustration of the OCEMC setup. The system is divided into four parts: OCEMC, GLMS, FPS and FSS. FIG. 1B provides a photographic depiction of the experimental setup corresponding to the schematic in FIG. 1A.

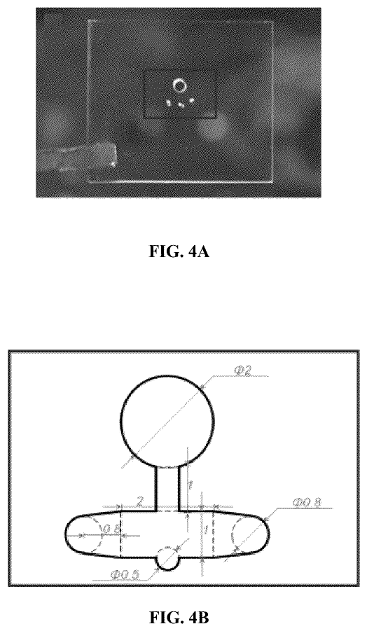

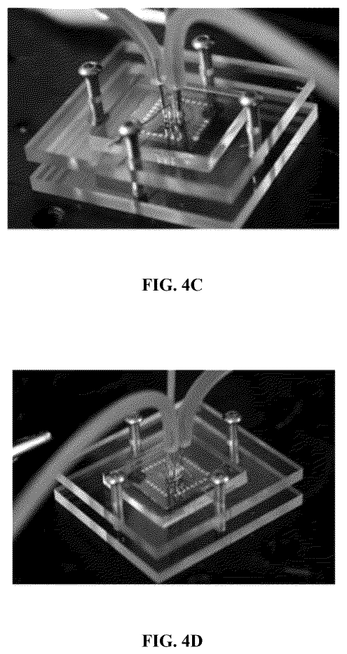

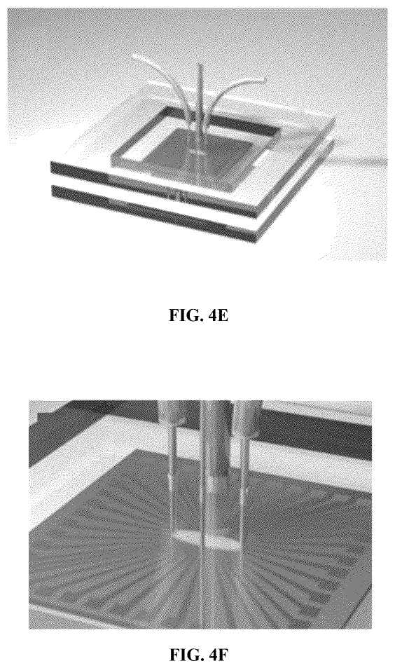

The OCEMC is the core of the entire system, ensuring that the microelectrode can undergo an electrochemical reaction in a microenvironment. Typically, constructing of OCEMC involves the step of preparing the complete polydimethylsiloxane (PDMS) chamber (FIG. 4A). First, the PDMS monomer and crosslinker (SYLGARD™ 184, Dow Corning) are mixed at a 10:1 ratio, stirred evenly, and then degassed with a vacuum pump to remove bubbles. The mixture is poured into a mold (FIG. 4B) and placed in an oven at 100° C. for 30 min to obtain a hydrophobic PDMS chamber. The PDMS is then activated with oxygen plasma to create a hydrophilic PDMS chamber. The plasma parameter are as follows: gas: oxygen (>99.999%; Linde HKO); pressure: 0.4 Torr; power: 18 W; time: 5 mins. The PDMS chamber is then perforated using a specialized puncher, with the holes on the left and right serving as the liquid inlet and outlet channels (0.8 mm sample needles). The upper and lower holes are designated for the reference electrode (2 mm Ag/AgCl) and the counter electrode (0.6 mm Pt wire), respectively. Next, the prepared chip is connected to the electrodes. Acetone is used to clean the PMMA off the gold pads, after which the pads are connected to 1 mm copper wires (ELECALL) using conductive silver paint (05002-AB, SPI). The assembly is then heated on a hotplate at 90° C. for 3 mins to ensure the complete evaporation of organic solvents in the silver paint. A multimeter (VICTOR 890C) is used to verify electrical continuity. The PDMS is then positioned over the chip, and a microscope is used to confirm that the microelectrode is centered in the middle of the channel. Two acrylic plates are used to hold them together and are secured with screws, with corresponding holes pre-drilled in the top acrylic plate, as shown in FIGS. 4C-4D. The entire chamber is sealed through the adhesion between the silicon wafer and PDMS. Finally, two syringe needles are inserted into the left and right holes, a platinum wire counter electrode is placed into the lower hole, and an Ag/AgCl reference electrode is inserted into the upper hole, completing the assembly of the OCEMC. The whole model is shown in FIGS. 4E-4F.

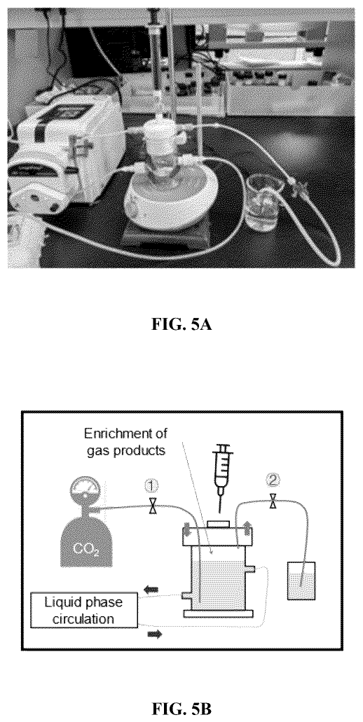

As shown in FIG. 5A, the core component of the GLMS is a gas-liquid mixing bottle. It serves dual purposes by ensuring thorough mixing of gas and liquid and facilitating the collection and extraction of gas products. In the typical setup depicted in FIG. 5B, CO₂ gas (>99.999%; Linde HKO) flows upward, with the inlet placed below the liquid surface in the bottle to ensure efficient gas-liquid mixing. The gas outlet is located above the liquid surface in the bottle to ensure internal gas pressure equilibrium, with an electrolyte seal at the end. At the top of the bottle, an injection port is equipped with a chromatography-specific rubber pad, designed for extracting gas products after the reaction is complete. The electrolyte circulation route flows downward, entering the circulation path at a lower position near the inlet to ensure proper CO₂ saturation of the pumped electrolyte.

During a standard test procedure, both switches \textcircled{1} and \textcircled{2} in FIG. 5B are opened simultaneously to introduce a substantial amount of CO₂ into the system, allowing subsequent CV and LSV tests to be conducted in a fully CO₂-saturated environment. Next, to conduct the tests under constant potential, switches \textcircled{1} and \textcircled{2} are closed together, allowing only the liquid circuit to circulate, which leads to the continuous generation of reaction products. After the designated accumulation period, switch \textcircled{2} is opened and switch \textcircled{1} is closed to allow gas products to be extracted from the top of the bottle using the injection syringe (1705; Hamilton) for further testing.

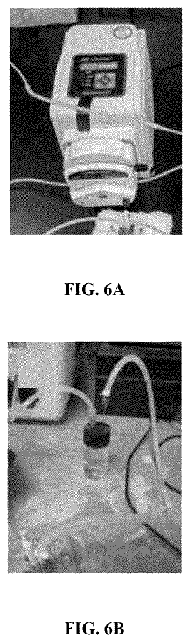

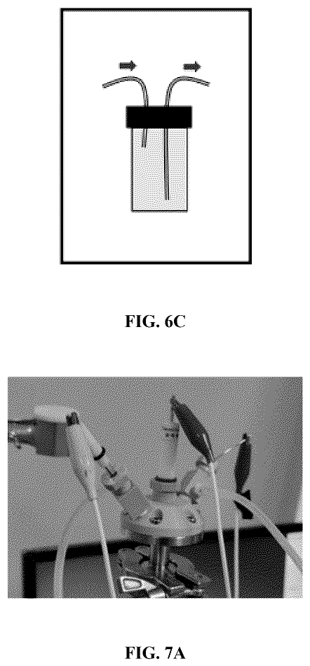

For FPS, as shown in FIG. 6A, the peristaltic pump (BT300-2J, Longer), which offers benefits such as continuous liquid flow, system closure, and prevention of backflow, serves as the primary power source for the entire mobile phase. It drives the liquid circulation by periodically compressing flexible tubing with rollers.

For FSS, the peristaltic pump operates cyclically, causing fluctuations in liquid flow. Additionally, the electrolyte's saturation with CO₂ and the tendency for CO₂ to precipitate under compression can lead to bubble formation within the liquid entering the OCEMC, potentially causing significant disruptions to the microcell. To solve these issues, FIGS. 6B-6C design the gas collection bottle to stabilize the liquid flow. As the liquid entered from the left side, any bubbles present would accumulate at the top of the bottle. Subsequently, due to pressure dynamics, the stabilized liquid exited from the right side, ensuring a steady flow.

These components work together to maintain continuous liquid circulation and system stability. The four systems described above are interconnected through microfluidic tubing, forming a cohesive closed-loop system.

### Example 6

### Electrochemical Testing of the Microfluidic-Based OCEMC

Initially, two electrolytes (0.5 M H₂SO₄, potassium bicarbonate (KHCO₃)) are prepared. To prepare the 0.5 M H₂SO₄ electrolyte, 80 mL of DI water is added to a 100 mL volumetric flask, and 2.72 mL of H₂SO₄ (98%; VWR) is slowly added using a pipette. Once the mixture has cooled to room temperature, the solution is diluted with DI water up to the 100 mL mark. The prepared electrolyte is then transferred to a Schott bottle for storage and later use. To prepare different concentrations of KHCO₃, 1.0011 g of KHCO₃ is added to a 100 mL volumetric flask, and approximately 50 mL of DI water is added to dissolve the KHCO₃. The solution is then diluted to 100 mL, resulting in a 0.1 M KHCO₃ electrolyte being obtained. Similarly, by adjusting the mass of KHCO₃ to 5 g and 10 g, electrolyte solutions with concentrations of 0.5 M and 1.0 M are prepared, respectively. The resulting electrolytes are then stored in Schott bottles for future use.

For the calibration of the reference electrode (RE), it is essential to accurately determine the potential of the leakless miniature Ag/AgCl RE (2 mm; leakless eDAQ, cat. no. ET072, Mengel Engineering), as this measurement is pivotal for precise data analysis. Prior to measurement, the leak-free miniature Ag/AgCl reference electrode and reversible hydrogen electrode (RHE; Gauss Union) are thoroughly cleaned with deionized water and electrolyte. The potential difference (Δφ) between the electrodes, when immersed in the electrolyte, is then measured using a multimeter. The measurement lasts for at least 5 min to obtain stable and accurate readings. The potential vs RHE is described by the Equation 1. Unless explicitly stated otherwise, φRHE in the following text is calculated using this method.

$${φ}_{RHE} = {φ}_{Ag / AgCl} + Δϕ . \qquad ( Equation 1 )$$

The FPS flow rate (ν) of the liquid over the catalyst surface is essential, as it underpins the subsequent quantitative calculations. The FPS flow rate can be calculated based on Equation 2.

$$v = {Q}_{f} / {A}_{0} , \qquad ( Equation 2 )$$

Q_{f} represents the pump's discharge and A₀ represents the cross-sectional area of the microchannel.

Typically, the cross-sectional area of the microchannel in the present invention is 0.8 mm³. A peristaltic pump reading of 20 sccm corresponds to an initial flow velocity of 0.4 m/s entering the channel.

To ensure the stability of the testing system and minimize external interference, the entire setup is positioned on an optical platform within a controlled, clean environment. The HER linear sweep voltammetry (LSV) measurement of the microelectrode is conducted as follows:
16 mL of DI water is added to the GLMS, and the FPS is activated to circulate the liquid while monitoring for any OCEMC leaks. Subsequently, 0.5 M H₂SO₄ electrolyte is introduced and circulated for 5 min to clean the system thoroughly, with the cleaning process repeated twice. Subsequently, a 0.5 M H₂SO₄ electrolyte saturated with N₂ is introduced, and N₂ is continuously bubbled through the GLMS to ensure full saturation. The complete system is then connected to modular potentiostats/galvanostats (Autolab PGSTAT302N) to establish a three-electrode system.

The HER activity of the microelectrodes, including gold, platinum, and 2H—MoS₂, are assessed using LSV, with the potential ranging from 0 V to −0.7 V vs Ag/AgCl and a scan rate of 10 mV/s. The FPS is turned on to control different flow rates and the influence curve of flow rate on LSV is obtained. The current density I is calculated based on the exposed area (A) of the PMMA window determined by the optical microscopy and the actual current (i), as shown in Equation 3. Unless otherwise specified, the current density (j) in the following text is calculated using this method.

$$j = i / A . \qquad ( Equation 3 )$$

To ensure the stability of the testing system and minimize external interference, the entire setup was positioned on an optical platform within a controlled, clean environment. The CO₂RR LSV measurement of the microelectrode is conducted as follows:

16 mL of DI water is added to the GLMS, and the FPS is activated to circulate the liquid, while monitoring for any OCEMC leaks. Subsequently, 0.5 M KHCO₃ electrolyte is introduced and circulated for 5 minutes to thoroughly clean the system, with the cleaning process repeated twice. Subsequently, 16 mL of 0.5 M KHCO₃ electrolyte saturated with CO₂ is introduced, and CO₂ is continuously bubbled through the GLMS to ensure saturation. The entire OCEMC system is then connected to modular potentiostats/galvanostats to configure a three-electrode setup.

The CO₂RR activities of the microelectrodes—comprising gold of varying sizes, platinum, copper, and WS₂ with different phases—are assessed via LSV in the potential range of 0 V to −1.7 V versus Ag/AgCl, with a scan rate of 10 mV/s. Typically, for WS₂ with different phases, the potential range is from 0 V to −1.3 V vs Ag/AgCl. The FPS is activated to control different flow rates, and the resulting flow rate dependence on the LSV response is recorded to obtain the influence curve.

As a comparison, a gold disk electrode (5 mm; Gauss Union) is tested in a typical three-electrode H-type cell, using a Nafion 117 ion-exchange membrane. The 0.5 M KHCO₃ electrolyte saturated with CO₂ is introduced into the H-type cell, and CO₂ is continuously bubbled through the cathode chamber to maintain saturation. The counter and reference electrodes are Pt mesh and Ag/AgCl, respectively. All electrical potentials in this testing system are referenced to the RHE scale for improved comparison, as shown in Equation 4. Then, the complete system is connected to modular potentiostats/galvanostats to configure a three-electrode setup.

$${φ}_{RHE} = {φ}_{Ag / AgCl} + 0.197 + 0.0 \; 591 pH . \qquad ( Equation 4 )$$

The CO₂RR activity of the gold disk electrode is evaluated using LSV, with a potential range of 0 V to −1.7 V vs Ag/AgCl and a scan rate of 10 mV/s.

### Example 7

### Gas Product Analysis for CO₂RR in the Microfluidic-Based OCEMC System

The constant potential i-t method is used to measure the products of CO₂RR at different potentials and flow rates. The specific accumulation method has been discussed in the previous paragraphs. The accumulation time is extended to over two hours to ensure that the products reach the lower detection limit of the gas chromatograph (GC; Agilent 7890B). The GC is pre-calibrated using four bottles of standard gases at varying concentrations (10 ppm, 50 ppm, 100 ppm, and 1000 ppm of H₂, CO, CH₄, C₂H₄, C₂H₆, respectively) to cover the entire low concentration range. The total volume of the OCEMC is 21 mL, with 16 mL of electrolyte circulating, allowing for 5 mL of product gas to be collected using a syringe. The gas is uniformly injected into the injection port and then split into three separate paths using a six-way valve.

The thermal conductivity detector (TCD) is primarily employed to detect hydrogen, while two flame ionization detector (FID) paths are used to detect CO and other hydrocarbons. FE can be calculated using the following Equation 5:

$$FE = \frac{p \times \frac{c \times {V}_{in , j}}{RT} \times n \times F}{{Q}_{total}} , \qquad ( Equation 5 )$$

where p is the atmospheric pressure (1 bar), C is the component concentration read by the GC, Vᵢₙⱼ is the injection volume, n is the number of electrons transferred to produce the product (such as CO, n is 2), F is the Faraday Constant (96500 C·mol⁻¹), R is the Gas Constant (8.314 J·K⁻¹·mol⁻¹), T is the room temperature (298 K) and Qₜₒₜₐₗ is the total charge accumulated by the electrochemical reaction obtained from the i-t curve.

Furthermore, gas product analysis for CO₂RR using the gold disk electrode is performed. The constant potential i-t method is employed to measure the CO₂RR products at various applied potentials. The online GC is used to test the FE at the 20 sccm flow rate. The FE can be calculated using the following Equation 6:

$$FE = \frac{p \times \frac{c \times {V}_{in , j}}{RT} \times n \times F}{{Q}_{t}} , \qquad ( Equation 6 )$$

where p is the atmospheric pressure (1 bar), C is the component concentration read by the GC, Fr is the gas flow rate, t is a dimensionless quantity used for unit conversion (1 min/60 s), n is the number of electrons transferred to produce the product, F is the Faraday Constant (96500 C·mol⁻¹), R is the Gas Constant (8.314 J·K⁻¹·mol⁻¹), T is the room temperature (298 K) and Qₜ is a real-time current from the i-t curve.

Moreover, liquid products for CO₂RR in a microfluidic-based OCEMC system and a gold disk electrodes are analyzed by a nuclear magnetic resonance spectroscopy (NMR 300 MHz, Bruker AVANCE III BBO Probe).

### Example 8

### In-Situ DEMS Analysis for CO₂RR in Microfluidic-Based OCEMC

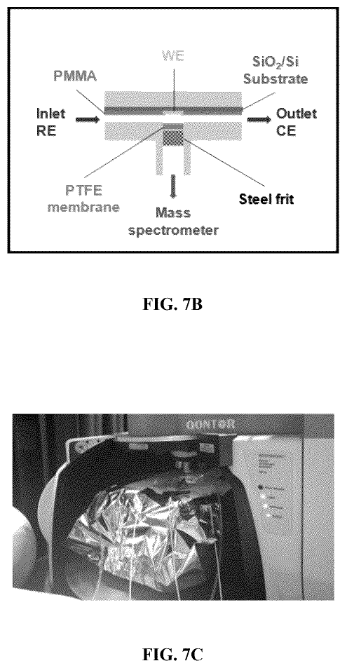

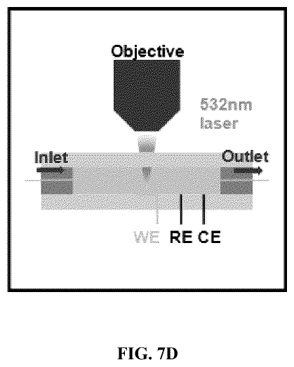

FIG. 7A shows the photograph of in-situ DEMS (QAS 100, Linglush) setup. FIG. 7B shows the schematic diagram of in-situ DEMS. This device allows for real-time detection of gas products generated during the reaction. The setup involves inverting the silicon wafer downward, with gas products from the reaction quickly evacuated by a vacuum pump below for analysis via mass spectrometry. A PTFE membrane is used to prevent liquid from entering the mass spectrometer.

### Example 9

### In-Situ Raman Analysis for CO₂RR in Microfluidic-Based OCEMC

FIG. 7C shows a photograph of the in-situ Raman setup, while FIG. 7D presents the schematic diagram of the in-situ Raman system. In-situ Raman spectroscopy enables real-time monitoring of molecular adsorption on the catalyst surface. Typically, this device, which differs slightly from the standard OCEMC, positions the working and reference electrodes facing downwards. An acrylic plate above facilitates light transmission to capture surface Raman signals. The connection setup, however, remains the same as that of the OCEMC.

In summary, the present invention establishes a comprehensive set of testing standards. As a versatile system, it integrates multiple in situ characterization techniques and catalytic reactions, enabling the screening of intrinsic activity, identification of active sites, investigation of reaction mechanisms, and precise control over individual variables for a wide range of materials.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments are chosen and described in order to best explain the principles of the invention and its practical application, thereby enabling others skilled in the art to understand the invention for various embodiments and with various modifications that are suited to the particular use contemplated.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “microfluidic chamber” refers to a structure designed for fluid manipulation at the microscale, comprising channels for the independent introduction of electrolytes and gaseous reactants, and integrated electrodes for facilitating electrocatalytic reactions.

The term “gas-liquid mixing system” refers to a subsystem configured to ensure homogeneous mixing of gaseous reactants and electrolytes within a mixing chamber, wherein the mixing is achieved through, e.g., mechanical agitation, gas sparging, or microfluidic diffusion.

The term “flow stabilization system” refers to a subsystem comprising a dampening chamber or other means for minimizing flow fluctuations, ensuring consistent liquid delivery to downstream components such as the microfluidic chamber.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### INDUSTRIAL APPLICABILITY

The novel microfluidic-based OCEMC system establishes a standardized approach for CO₂RR testing, which is applicable for intrinsic activity screening of various materials, identifying active sites, exploring reaction mechanisms, and controlling single variables. With its efficient mass transfer capabilities, the system has demonstrated that 1T′-WS₂ can serve as a low-cost, viable alternative catalyst for CO₂RR, highlighting its potential for widespread use in electrocatalytic applications. Furthermore, as a scalable interface, this system can integrate multiple in-situ characterization techniques and catalytic reactions, offering broad multidimensional application prospects. Additionally, it enables the study of the intrinsic catalytic activity of materials, facilitating effective catalyst screening and providing a foundational database for selecting catalysts in industrial gas diffusion electrodes.

What is claimed is:

1. A microfluidic-based on-chip electrocatalytic microcell system, comprising:
a microfluidic chamber configured to introduce an electrolyte and a gaseous reactant through independent channels, wherein the microfluidic chamber comprises inlet ports and outlet ports for continuous flow of the electrolyte, and integrated electrodes positioned to enable electrocatalytic reactions;
a gas-liquid mixing system with a mixing chamber configured to ensure homogeneous mixing of the gaseous reactant and the electrolyte, wherein the gas-liquid mixing system connect with the microfluidic chamber;
a flow power system with at least one peristaltic pump connected to the microfluidic chamber to control the flow rate of the electrolyte within the microfluidic chamber; and
a flow stabilization system with a flow-dampening chamber to mitigate flow fluctuations and maintain stable liquid delivery to the microfluidic chamber;
wherein the microfluidic-based on-chip electrocatalytic microcell system is capable of optimizing diffusion-driven reactions, minimizing external interference, and facilitating reaction efficiency in carbon dioxide reduction reactions (CO₂RR).

2. The microfluidic-based on-chip electrocatalytic microcell system of claim 1, wherein the electrolyte comprises a thin-layer flow phase electrolyte.

3. The microfluidic-based on-chip electrocatalytic microcell system of claim 1, wherein the microfluidic chamber is fabricated using polydimethylsiloxane (PDMS) treated with oxygen plasma to create a hydrophilic surface.

4. The microfluidic-based on-chip electrocatalytic microcell system of claim 1, wherein the gas-liquid mixing system comprises an injection port for collecting gas products post-reaction.

5. The microfluidic-based on-chip electrocatalytic microcell system of claim 1, wherein the integrated electrodes comprise materials selected from gold, copper, platinum, and transition metal dichalcogenides (TMDs), and the integrated electrodes are recessed and coated with a polymer to create a defined reaction area.

6. The microfluidic-based on-chip electrocatalytic microcell system of claim 1, wherein the flow power system comprises a feedback mechanism to dynamically adjust the flow rate based on detected pressure changes.

7. The microfluidic-based on-chip electrocatalytic microcell system of claim 1, wherein the flow stabilization system comprises a gas collection chamber designed to remove air bubbles from the liquid electrolyte before entry into the microfluidic chamber.

8. The microfluidic-based on-chip electrocatalytic microcell system of claim 1, wherein the microfluidic-based on-chip electrocatalytic microcell system further comprising in situ analytical tools for real-time monitoring of catalytic reactions.

9. The microfluidic-based on-chip electrocatalytic microcell system of claim 8, wherein the in situ analytical tools comprise Raman spectroscopy and differential electrochemical mass spectrometry (DEMS).

10. A method for fabricating a microfluidic-based on-chip electrocatalytic microcell system, comprising:
fabricating a microelectrode array on a substrate to create precise patterns;
assembling a microfluidic chamber; and
integrating a gas-liquid mixing system, a flow power system, and a flow stabilization system with the microfluidic chamber, all interconnected via microfluidic channels, to form an assembled microfluidic-based on-chip electrocatalytic microcell system.

11. The method of claim 10, wherein the microelectrode array is fabricated using gold, copper, platinum, or 2D transition metal dichalcogenides (TMDs) to enhance catalytic performance.

12. The method of claim 10, wherein the substrate comprises silicon wafer.

13. The method of claim 10, wherein step of assembling a microfluidic chamber comprises:
preparing a polydimethylsiloxane (PDMS) chamber with pre-defined inlet and outlet ports; and
attaching the PDMS chamber to the microelectrode array using plasma activation.

14. The method of claim 13, wherein the PDMS is fabricated by mixing a PDMS monomer and a crosslinker in a 9-15:1 ratio, degassing under vacuum, and curing at 90-110° C. for 20-40 minutes.

15. The method of claim 13, wherein the plasma activation of the PDMS chamber is performed using oxygen plasma at a pressure of 0.1-0.5 Torr, a power of 10-20 W, and a duration of 1-10 minutes to enhance adhesion to the silicon wafer.

16. The method of claim 10, wherein the gas-liquid mixing system comprises a mixing chamber designed to ensure thorough gas-liquid interaction and prevent bubble formation before introduction into the microfluidic chamber.

17. The method of claim 10, wherein the flow power system utilizes the peristaltic pump to maintain a flow rate between 5 and 100 mL/min, ensuring consistent electrolyte delivery and optimal mass transfer.

18. The method of claim 9, wherein the flow stabilization system comprises a flow-dampening chamber configured to stabilize liquid flow and eliminate pulsations caused by the peristaltic pump.

19. The method of claim 10, further comprising integrating in situ analytical tools comprising Raman spectroscopy and differential electrochemical mass spectrometry (DEMS), for real-time monitoring of catalytic reactions.

20. The method of claim 10, further comprising validating the assembled microfluidic-based on-chip electrocatalytic microcell system for electrical continuity and sealing performance, ensuring minimal dead volume and optimized mass transfer for CO₂RR applications.
